(19) United States
(12) Patent Application Publication
(10) Pub. No.: US 2009/0041398 A1
(43) Pub. Date: Feb. 12, 2009

(54) BEARING STRUCTURE FOR VARIABLE-COMPRESSION-RATIO INTERNAL COMBUSTION ENGINE

(75) Inventors: Yoshiaki Tanaka, Fujisawa-shi (JP); Naoki Takahashi, Yokohama-shi (JP); Masayuki Tomita, Fujisawa-shi (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 12/177,585

(22) Filed: Jul. 22, 2008

(30) Foreign Application Priority Data
Aug. 10, 2007 (JP) 2007-209538

(51) Int. Cl. F16C 9/02

(52) U.S. Cl. 384/429

(57) ABSTRACT

An internal combustion engine varies a compression ratio according to a rotational displacement of a control shaft which is connected to a crankshaft via links. A crankshaft bearing cap supporting the crankshaft in association with a cylinder block is fixed to the cylinder block by a first pair of joint bolts. A control shaft bearing cap which supports the control shaft is fixed to the crankshaft bearing cap by a second pair of joint bolts. A first joint bolt of the first pair of joint bolts, which is nearer to the control shaft, is disposed between the axes of the second pair of joint bolts. The supporting structure of the crankshaft is thereby enhanced.

### FIELD OF THE INVENTION

This invention relates to a bearing structure for a double-link type variable-compression-ratio internal combustion engine in which a piston and a crankshaft are connected via plural links.

### BACKGROUND OF THE INVENTION

JP2004-092448A, published by the Japan Patent Office in 2004, discloses a double-link type variable-compression-ratio internal combustion engine. The internal combustion engine comprises a piston and a crankshaft connected via an upper link and a lower link. An end of a control link is connected to the lower link. Another end of the control link is connected to a control shaft which is disposed in parallel with the crankshaft. When the control shaft performs a rotational displacement, the lower link rotates with respect to the crankshaft and a refracting angle between the upper link and the lower link varies such that a stroke range of the piston varies, bringing about a variation in the compression ratio of the internal combustion engine.

The double-link type internal combustion engine according to the prior art comprises a crankshaft bearing cap fixed to a cylinder block of the internal combustion engine and a control shaft bearing cap fixed to the crankshaft bearing cap. The crankshaft bearing cap and the control shaft bearing cap are located on an identical vertical plane.

A semi-circular cutout is formed in the top surface of the crankshaft bearing cap. Another semi-circular cutout is formed in a bottom surface of the cylinder block of the internal combustion engine. The crankshaft penetrates a bearing bore having a circular cross-section formed by this pair of the semi-circular cutouts.

A semi-circular cutout is formed in the top surface of the control shaft bearing cap. Another semi-circular cutout is formed in the bottom surface of the crankshaft bearing cap. The control shaft penetrates a bearing bore having a circular cross-section formed by this pair of the semi-circular cutouts.

The control shaft bearing cap is fixed to the crankshaft bearing cap using two joint bolts which penetrate the control shaft bearing cap vertically on both sides of the control shaft. The two joint bolts also penetrate the crankshaft bearing cap and are secured to the cylinder block in the vicinity of the bearing surface formed in the cylinder block. Therefore, the two joint bolts also serve to fix the crankshaft bearing cap to the cylinder block.

An extra bolt penetrates the crankshaft bearing cap on the opposite side of the crankshaft to the control shaft and is secured to the cylinder block.

### SUMMARY OF THE INVENTION

In a double-link type internal combustion engine, relative locations of the crankshaft, the control shaft, and the links (hereinafter referred to as link geometry) are not constant. In an internal combustion engine having a different piston stroke range or a different cylinder bore diameter, preferred link geometry for suppressing noise or oscillation generated in the internal combustion engine may also be different.

In certain cases, link geometry which causes the crankshaft and the control shaft to become adjacent in a horizontal direction when viewed axially along the crankshaft is required. If such a requirement arises in the bearing structure according to the prior art, of the two joint bolts that secure the control shaft bearing cap to the crankshaft bearing cap, the joint bolt disposed between the crankshaft and the control shaft may interfere with the crankshaft. If this is the case, to avoid interference with the crankshaft, the joint bolt cannot be allowed to penetrate the crankshaft bearing cap. Accordingly, the crankshaft bearing cap is secured to the cylinder block by only two bolts, i.e. one of the pair of the joint bolts and the extra bolt. These bolts are located at both side ends of the crankshaft bearing cap.

This structure causes a distance between the joint bolt located on the opposite side of the control shaft to the crankshaft and the extra bolt to increase such that the crankshaft bearing cap can be deformed easily when the internal combustion engine exerts a downward combustion load on the crankshaft. If the crankshaft bearing cap is deformed, a gap may be generated between the crankshaft bearing cap and the cylinder block.

The generation of a gap results in an excessive internal stress in the components of the bearing structure. Further, joint surfaces of the crankshaft bearing cap and the cylinder block may suffer wear due to oscillation during stress, or in other words fretting wear.

According to the fixing structure of the crankshaft bearing cap and the control shaft bearing cap according to the prior art, however, it is difficult to maintain close contact between the crankshaft bearing cap and the cylinder block against the downward load that the internal combustion engine exerts on the crankshaft.

It is therefore an object of this invention to improve a fixing structure for fixing the crankshaft bearing cap to the cylinder block in a double-link type variable-compression-ratio internal combustion engine.

In order to achieve the above object, this invention provides a bearing structure for an internal combustion engine, the engine comprising a cylinder block, a crankshaft, and a control shaft. The bearing structure comprises a cutout formed in the cylinder block, a crankshaft bearing cap having a cutout which functions as a bearing bore for the crankshaft in association with the cutout of the cylinder block, a first pair of joint bolts which fix the crankshaft bearing cap to the cylinder block, the first pair of joint bolts comprising a first joint bolt which is located nearer to the control shaft than another joint bolt of the first pair, a control shaft bearing cap which has a cutout functioning as a bearing bore for the control shaft, and a second pair of joint bolts which fix the control shaft bearing cap to the crankshaft bearing cap, wherein a center axis of the first joint bolt is located between center axes of the second pair of joint bolts.

The details as well as other features and advantages of this invention are set forth in the remainder of the specification and are shown in the accompanying drawings.

### BRIEF DESCRIPTION OF THE DRAWINGS

FIG. 1 is a schematic longitudinal sectional view of a double-link type variable-compression-ratio internal combustion engine to which this invention is applied.

FIGS. 2A and 2B are a schematic front view and a schematic side view of a crankshaft bearing cap and a control shaft bearing cap according to this invention.

FIG. 3 is an enlarged schematic front view of the control shaft bearing cap, showing the construction thereof in detail.

FIG. 4 is a schematic front view of the crankshaft bearing cap and the control shaft bearing cap, showing a loading condition.

FIG. 5 is a perspective view of the crankshaft bearing cap and the control shaft bearing cap in an inverted state.

FIGS. 6A and 6B are similar to FIGS. 2A and 2B but showing a variation with respect to the composition of the control shaft bearing cap.

FIG. 7 is a schematic front view of a variation of the crankshaft bearing cap and the control shaft bearing cap that is preferable for mitigating loads acting on the control shaft.

FIG. 8 is a front view of the control shaft and a connecting pin, showing preferable relative positions thereof.

### DESCRIPTION OF THE PREFERRED EMBODIMENTS

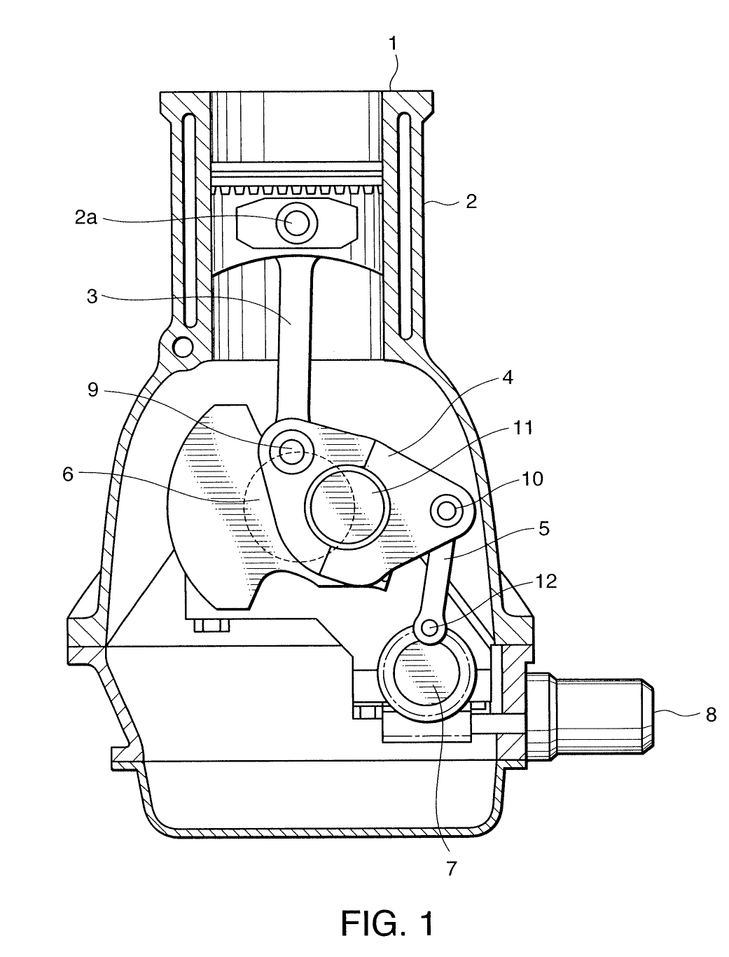

Referring to FIG. 1 of the drawings, a double-link type variable-compression-ratio internal combustion engine to which this invention is applied comprises a cylinder block 1. A cylinder is formed in the cylinder block 1 and a piston 2 is enclosed in the cylinder so as to slide axially within the cylinder. An end of an upper link 3 is connected to the piston 2 via a piston pin 2a. Another end of the upper link 3 connected to a lower link 4 via a connecting pin 9. The lower link 4 is connected to a crankshaft 6 via a crankpin 11.

According to the above construction, when the piston 2 slides in the cylinder up and down in the figure, the crankshaft 6 performs a rotational movement via the upper link 3 and the lower link 4.

The stroke range of the piston 2 within the cylinder varies depending on an angle subtended by the piston pin 2a and the crankpin 11 at the connecting pin 9.

To vary this angle, an end of a control link 5 is connected to the lower link 4 via a connecting pin 10. The connecting pin 10 connects an end of the control link 5 to the lower link 4 on the opposite side of the crankpin 11 to the connecting pin 9. Another end of the control link 5 is connected to a control shaft 7 via a connecting pin 12. The crankshaft 6 and the control shaft 7 have rotation axes which extend in parallel with each other.

The connecting pin 12 connects the control link 5 to the control shaft 7 at a point eccentric with a rotation axis of the control shaft 7. The control shaft 7 performs a rotational displacement according to an operation of an actuator 8 constituted by an electric motor.

When the control shaft 7 performs a rotational displacement, the lower link 4 performs a rotational displacement about the crankpin 11 via the control link 5 which is connected to the control shaft 7 at a point eccentric with the rotation axis, and the angle subtended by the piston pin 2a and the crankpin 11 at the connecting pin 9 varies. When this angle varies, the stroke range of the piston 2 shifts. The shift of the stroke range of the piston 2 results in a variation in the compression ratio of the internal combustion engine.

When the position of the connecting pin 12 lowers relative to the rotation axis of the control shaft 7 as a result of the rotational displacement of the control shaft 7, the position of the connecting pin 10 also lowers and the lower link 4 performs a rotational displacement about the crankpin 11 in a clockwise direction in the figure so as to push up the connecting pin 9. This action shifts the stroke range of the piston 2 upward in the figure, thereby causing the compression ratio of the internal combustion engine to increase.

When the position of the connecting pin 12 rises relative to the rotation axis of the control shaft 7 as a result of the rotational displacement of the control shaft 7, the position of the connecting pin 10 also rises and the lower link 4 performs a rotational displacement about the crankpin 11 in an anti-clockwise direction in the figure so as to pull down the connecting pin 9. This action shifts the stroke range of the piston 2 downward in the figure, thereby causing the compression ratio of the internal combustion engine to decrease.

The internal combustion engine operates at a low compression ratio in a high-load operation region irrespective of the engine rotation speed so as to prevent knock from occurring while operating at a high compression ratio in a low-to-middle-load operation region where knock is unlikely to occur so as to increase an output power.

The bearing structure according to this invention relates to a bearing for the crankshaft 6 and a bearing for the control shaft 7 of the internal combustion engine constructed as described above.

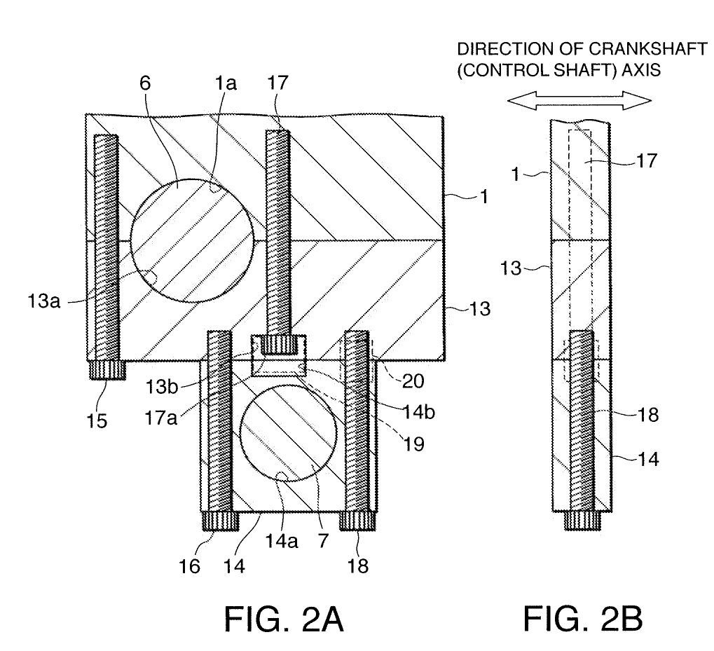

Referring to FIG. 2A, a main journal of the crankshaft 6 is supported by a bearing installed in a circular bearing bore which is constituted by a semi-circular cutout 13a formed in a crankshaft bearing cap 13 and a semi-circular cutout la formed in the cylinder block 1. The control shaft 7 is supported by a bearing installed in a circular bearing bore constituted by a circular cutout 14a which is formed in a control shaft bearing cap 14. This figure represents a state where the bearing caps 13, 14 are viewed from the front of the engine.

The crankshaft bearing cap 13 is fixed to the cylinder block 1 using joint bolts 15 and 17. The control shaft bearing cap 14 is fixed to the crankshaft bearing cap 13 using joint bolts 16 and 18. In the following description, the joint bolts 15 and 17 are referred to as a first pair of joint bolts and the joint bolts 16 are 18 are referred to as a second pair of joint bolts.

The first pair of joint bolts 15 and 17 penetrate through-holes formed in the crankshaft bearing cap 13 on both sides of the cutout 13a from below, and are screwed into bolt holes formed in the cylinder block 1 on both sides of the cutout 1a.

The second pair of joint bolts 16 and 18 penetrate through-holes formed in the control shaft bearing cap 14 on both sides of the cutout 14a from below, and are screwed into bolt holes formed in the crankshaft bearing cap 13 on both sides of the joint bolt 17. The joint bolt 17 is disposed such that an axis of the joint bolt 17 intersects with the control shaft 7.

As a result, the joint bolt 16 is located between the axes of the joint bolt 15 and the joint bolt 17, and the joint bolt 17 is located between the axes of the joint bolt 16 and the joint bolt 18. In other words the joint bolt 17 is located nearer to the control shaft 7 than the joint bolt 15, and the joint bolt 18 is located further from the crankshaft 6 than the joint bolt 16. The joint bolt 17 is referred to as a first joint bolt and the joint bolt 18 is referred to as a second joint bolt in the following description.

Referring to FIG. 2B, the crankshaft bearing cap 13 and the control shaft bearing cap 14 are located in an identical location along the axis of the crankshaft 6. In other words, the crankshaft bearing cap 13 and the control shaft bearing cap 14 are disposed on an identical vertical plane which is orthogonal to the axis of the crankshaft 6.

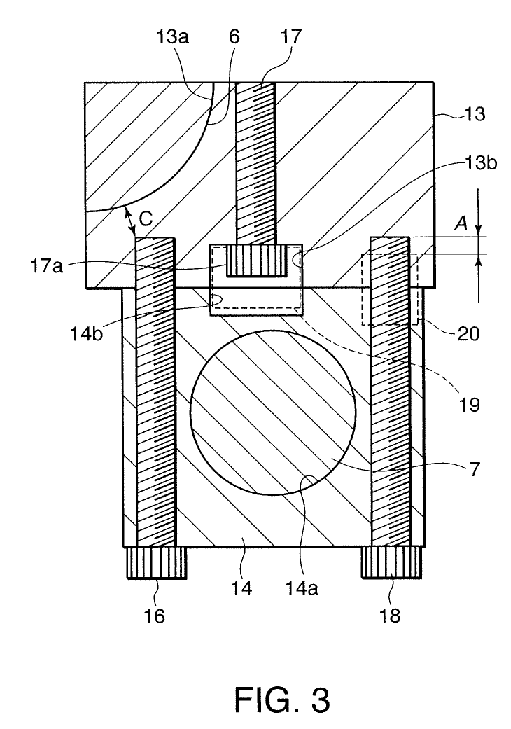

Referring to FIG. 3, a first countersink 13b is formed in a bottom surface of the crankshaft bearing cap 13 in advance so as to accommodate a bolt head 17a of the first joint bolt 17. A second countersink 14b is also formed in advance in a corresponding part in a top surface of the control shaft bearing cap 14.

A positioning member 19 is embedded in the first countersink 13b. The positioning member 19 projects downward from the first countersink 13b and is inserted into the second countersink 14b when the control shaft bearing cap 14 is fixed to the crankshaft bearing cap 13. The positioning member 19 is preferably formed from a cylindrical member having an inner diameter that does not interfere with the bolt head 17a of the first joint bolt 17, but a cylindrical member having an inner diameter smaller than the diameter of the bolt head 17a or a solid columnar member may also be used as long as a sufficient fitting length between the positioning member 19 and the first countersink 13b is assured.

A cylindrical positioning member 20 is embedded in a bolt hole formed in the crankshaft bearing cap 13 for the second joint bolt 18. For this purpose, an enlarged diameter part is formed in advance in the bolt hole formed in the crankshaft bearing cap 13 for the second joint bolt 18, and the positioning member 20 is embedded therein. A similar enlarged diameter part is formed in a bolt hole formed in the control shaft bearing cap 14 for the second joint bolt 18. The positioning member 20 projects downward from the crankshaft bearing cap 13, and is inserted into the enlarged diameter part of the bolt hole formed in the control shaft bearing cap 14 for the second joint bolt 18 when the control shaft bearing cap 14 is fixed to the crankshaft bearing cap 13.

Positioning is thus performed at two points using the two positioning members 19 and 20 when the control shaft bearing cap 14 is fixed to the crankshaft bearing cap 13, and as a result, relative positioning of the bearing for the crankshaft 6 and the bearing for the control shaft 7 can be performed with a high degree of precision.

The second joint bolt 18 is screwed into the bolt hole formed in the crankshaft bearing cap 13 after penetrating the positioning member 20. An engagement length A between the second joint bolt 18 and the bolt hole of the crankshaft bearing cap 13 is determined such that the second joint bolt 18 exerts a sufficient tightening force on the control shaft bearing cap 14 with respect to the crankshaft bearing cap 13. Since there is no component that may interfere with the second joint bolt 18 in the crankshaft bearing cap 13 above the positioning member 20, the bolt hole can be formed at a sufficient length.

It is also possible to provide a similar positioning member in a bolt hole for the other joint bolt 16 of the second pair of the joint bolts 16, 18. However, when the crankshaft 6 is located in a position corresponding to an extension of the joint bolt 16, it may be difficult to obtain a sufficient engagement length between the joint bolt 16 and the corresponding bolt hole of the crankshaft bearing cap 13 which is located above the positioning member. In other words, a covering depth C of the crankshaft bearing cap 13 with respect to the crankshaft 6 shown in FIG. 3 inevitably becomes too thin to ensure a sufficient engagement length between the joint bolt 16 and the bolt hole. If the covering depth C is thin, this part suffers a concentration of stress caused by the combustion load of the internal combustion engine acting on the bearing for the crankshaft 6.

It is therefore preferable to dispose the positioning members 19 and 20 around the joint bolts 17 and 18 so as to ensure a sufficient covering depth of the crankshaft 6.

It is also possible to cause the bolt head 17a of the first joint bolt 17 to project into the second countersink 14b located on the control shaft side. However, to prevent strain from occurring in the control shaft bearing cap 14 due to the combustion load of the internal combustion engine, which acts on the bearing for the crankshaft 6, the second countersink 14b formed in the control shaft bearing cap 14 is preferably made shallow. By ensuring that the bolt head 17a of the first joint bolt 17 does not project into the second countersink 14b but remain in the first countersink 13b of the crankshaft bearing cap 13, the second countersink 14b can be made shallow to an extent that does not affect the positioning precision of the positioning member 19.

By decreasing the depth of the second countersink 14b, the center of the control shaft 7 can be disposed nearer to the crankshaft bearing cap 13. As a result, the vertical distance between the crankshaft 6 and the control shaft 7 can be decreased and the variable-compression-ratio internal combustion engine can be made more compact.

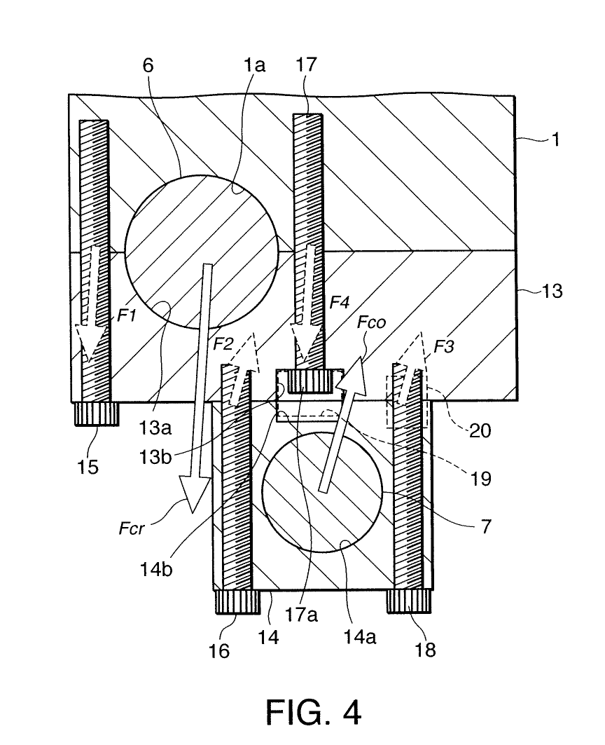

Referring to FIG. 4, the loads acting on the crankshaft bearing cap 13, the cylinder block 1, and the control shaft bearing cap 14 will be described.

An arrow Fcr in the figure denotes a load acting on the bearing for the crankshaft 6 when the combustion load of the internal combustion engine is exerted on the crankshaft 6. An arrow Fco in the figure denotes a load acting on the bearing for the control shaft 7 when the combustion load of the internal combustion engine is exerted on the crankshaft 6. A broken line arrow F1 denotes a component of the load Fcr exerted on the joint bolt 15. A broken line arrow F4 denotes a component of the load Fcr exerted on the first joint bolt 17. A broken line F2 denotes a component of the load Fco exerted on the joint bolt 16. A broken line arrow F3 denotes a component of the load Fco exerted on the second joint bolt 18.

The direction of the load Fcr depends on the link geometry of the internal combustion engine. Herein, the load Fcr is assumed to act obliquely downward as shown in the figure. The direction of the load Fco depends on the link geometry and a set compression ratio, but approximated to act in an opposite direction to that of the load Fcr. i.e. in an obliquely upward direction in the figure.

The load Fcr exerts a load F1 on the joint bolt 15 and a load F4 on the first joint bolt 17. The load Fco exerts a load F2 on the joint bolt 16 and a load F3 on the second joint bolt 18.

The loads Fcr and Fco exert a moment on the first joint bolt 17. This moment exerts a shearing force on the first joint bolt 17 in the vicinity of the joint surfaces of the cylinder block 1 and the crankshaft bearing cap 13.

Generally, a bolt should be used in a condition in which only tensile stress or compression stress is generated therein. It is not preferable to use a bolt under an action of a moment or a resultant shearing force in view of ensuring the strength and durability of the bolt.

According to thus bearing structure, the layout of the bolts is determined such that an axis of the first joint bolt 17 is located between the joint bolt 16 and the second joint bolt 18. Accordingly, an arm length of the moment which the load Fco exerts on the first joint bolt 17 is short, and hence a moment and a shearing force acting on the first joint bolt 17 are suppressed to be small. Further, the loads F2 and F3 act on the crankshaft bearing cap 13 substantially in the opposite direction to the load F4. Since these loads are counterbalanced, an axial force exerted on the first joint bolt 17 is also small.

According to the above construction of the bearing structure, the allowable stress of the first joint bolt 17 can be decreased. As a result, the diameter of the first joint bolt 17 can be made smaller or a lower class bolt in terms of strength may be applied as the first joint bolt 17 so as to reduce the manufacturing cost of the bearing structure.

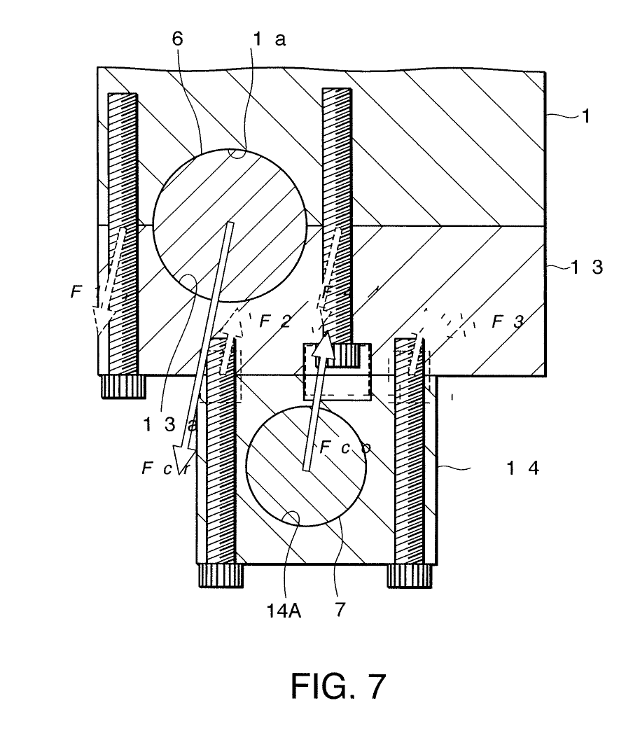

Referring to FIG. 7, when the load Fco is directed toward the cross-sectional face of the first joint bolt 17 corresponding to the joint surfaces of the cylinder block 1 and the crankshaft bearing cap 13 (hereinafter referred to as a shearing force acting portion of the joint bolt 17), the moment acting on the first joint bolt 17 is kept small. The vertical component of the load Fco coincides with the axis of the joint bolt 17, and therefore, if the center of the control shaft 7 is located on the axis of the first joint bolt 17, the moment acting on the first joint bolt 17 is decreased further.

The direction of the load Fco varies according to the compression ratio of the internal combustion engine. It is not possible to control the direction of the load Fco to direct the shearing force acting portion of the first joint bolt 17 permanently irrespective of the variation in the compression ratio. It is preferable to determine the location of the first joint bolt 17 with respect to the link geometry such that the load Fco directs the shearing force acting portion of the first joint bolt 17 at least in an operation condition of the internal combustion engine, in which a large combustion load is generated.

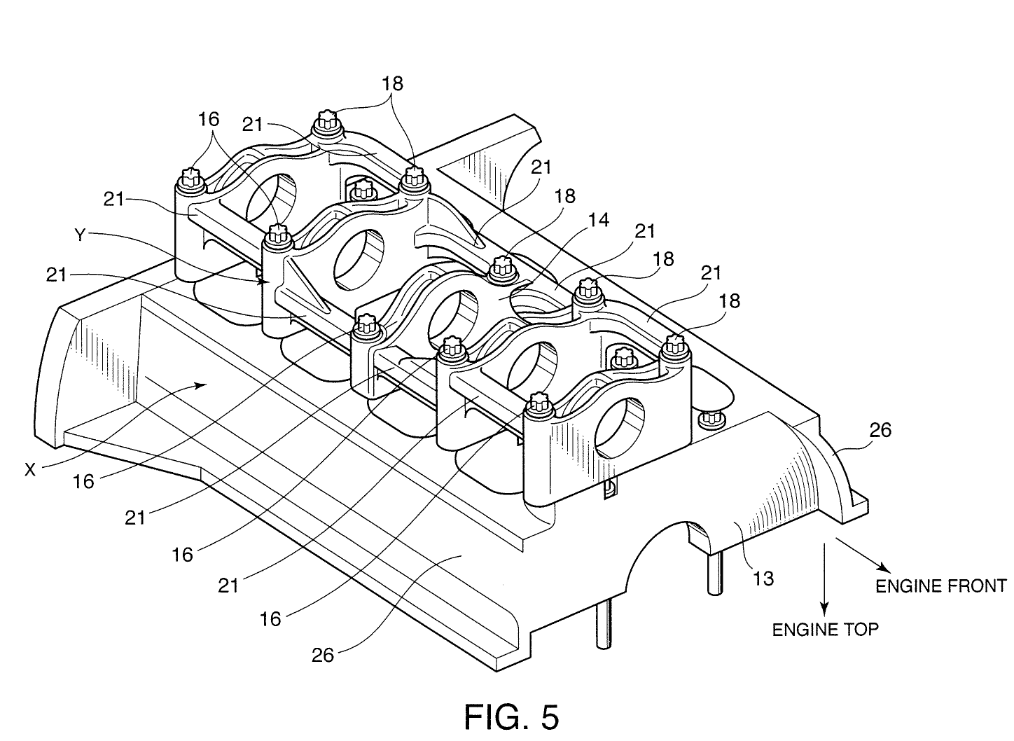

Referring to FIG. 5, a shape of the crankshaft bearing cap 13 and the control shaft bearing cap 14 when the bearing structure of the crankshaft 6 and the control shaft 7 constructed as described above is applied to an in-line four-cylinder internal combustion engine will be described.

The crankshaft bearing caps 13 for the respective cylinders form a ladder beam shape bearing cap structure X by connecting both side ends of the crankshaft bearing caps 13 with a pair of walls 26, respectively. The pair of walls 26 connecting both side ends of the crankshaft bearing caps 13 form a skirt of the cylinder block 1.

The control shaft bearing caps 14 for the respective cylinders form a ladder beam-shaped bearing cap structure Y by connecting both side ends of the control shaft bearing caps 14 via girders 21, respectively.

When the crankshaft bearing caps 13 and the control shaft bearing caps 14 are provided in the form of the ladder beam-shaped bearing cap structure X and the ladder beam-shaped bearing cap structure Y, it is possible to eliminate the positioning member 20 disposed around the second joint bolt 18. It is enough to provide at least two of the control shaft bearing caps 14 with the positioning members 19. When at least two of the control shaft bearing caps 14 are provided with the positioning members 19, positioning of the bearing for the crankshaft 6 and the bearing for the control shaft 7 can be performed.

The shape and the location of the girder 21 connecting the control shaft bearing caps 14 are not limited to those shown in FIG. 5. They can be determined according to the distribution of stresses and the layout of the related members.

The ladder beam bearing cap structure Y constructed from the plural control shaft bearing caps 14 limits the shape of the control shaft 7.

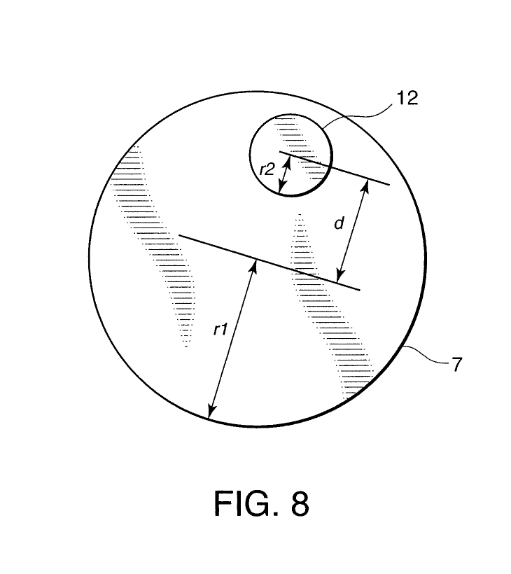

Referring to FIG. 8, it is assumed that a radius of the control shaft 7 is r1, a radius of the connecting pin 12 connecting the control link 5 to the control shaft 7 is r2, and an eccentric distance of the center of the connecting pin 12 from the center of the control shaft 7 is d. It is preferable to determine the sizes of the control link 5, the control shaft 7, and the connecting pin 12 such that the following relation (1) is satisfied.

r1≧r2+d (1)

When the relation (1) is satisfied, the outer periphery of the connecting pin 12 does not protrude to the outside from the outer periphery of the control shaft 7 in a state where the control shaft 7 is viewed from an axial direction. When assembling the internal combustion engine, as long as this relation is satisfied, the control shaft 7 can be inserted into the plural cutouts 14a sequentially from the front side or rear side of the internal combustion engine in a state where the ladder beam bearing cap structure Y is tentatively fixed to the bottom surface of the ladder beam-shaped bearing cap structure X.

As described above, by forming the ladder beam bearing cap structure Y by plural control shaft bearing caps 14, the supporting rigidity of the control shaft 7 is enhanced. By thus enhancing the supporting rigidity of the control shaft 7, deformation of the control shaft 7 is suppressed. As a result, the weight of the control shaft can be decreased, thereby decreasing a moment of inertia acting on the control shaft 7 about the rotation axis of the control shaft 7.

A decrease in the moment of inertia brings about a decrease in the load of the actuator 8, and therefore a preferable effect is expected in terms of a reduction in the energy consumed by the actuator 8 and an improvement in the operation response of the control shaft 7.

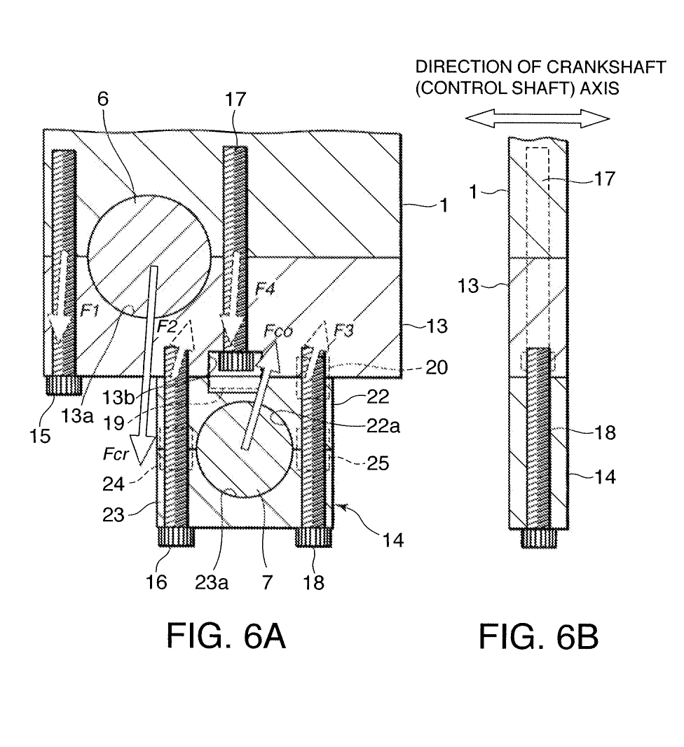

Referring to FIGS. 6A and 6B, a variation with respect to the construction of the control shaft bearing cap 14 will be described.

Herein, the control shaft bearing cap 14 is divided into an upper member 22 and a lower member 23.

When the control shaft bearing cap 14 is divided, positioning of the lower member 23 with respect to the upper member 22 is required. For this purpose, a positioning member 24 is embedded in the bolt hole for the joint bolt 16 across the joint surfaces of the upper member 22 and the lower member 23, and a positioning member 25 is embedded in the bolt hole for the second joint bolt 18 across the joint surfaces of the upper member 22 and the lower member 23.

When the internal combustion engine is assembled, the control shaft 7 is first fitted into a cutout 22a of the upper member 22 and then the lower member 23 is fixed to the upper member 22 using the joint bolts 16 and 18 such that the control shaft 7 is supported by the cutout 22a and a cutout 23a.

By thus dividing the control shaft bearing cap 14, the limitation with respect to the radius r1 of the control shaft 7, the radius r2 and the eccentric distance d of the connecting pin 12, which is represented by the relation (1), can be relaxed such that the control shaft 7 can be fitted into the control shaft bearing cap 14 easily.

Instead of using the joint bolts 15 and 17, stud bolts may be embedded into the cylinder block 1 so as to project downward from the bottom surface. These stud bolts penetrate the crankshaft bearing cap 13 and nuts are tightened onto the penetrating end of the stud bolts. Similarly, instead of using the joint bolts 16 and 18, stud bolts may be embedded into the crankshaft bearing cap 13 so as to project downward from the bottom surface. These stud bolts penetrate the upper member 22 and the lower member 23 of the control shaft bearing cap 14 and nuts are tightened onto the penetrating end of the stud bolts.

As can be seen in FIG. 2B and FIG. 6B, in the embodiment described above, the crankshaft bearing cap 13 and the control shaft bearing cap 14 are disposed on an identical vertical plane. These bearing caps may be disposed in offset positions along the rotation axis of the crankshaft 6. In this case, the crankshaft bearing cap 13 is fixed to the cylinder block 1 using bolts whereas the control shaft bearing cap 14 is fixed to either the crankshaft bearing cap 13 or the cylinder block 1 using other bolts.

By disposing the crankshaft bearing cap 13 and the control shaft bearing cap 14 in offset positions along the rotation axis of the crankshaft 6, the bolts can penetrate both side ends of the bearing caps without restriction. According to this arrangement, deformation of the crankshaft bearing cap 13 and the resultant generation of a gap in the joint surfaces of the crankshaft bearing cap 13 and the control shaft bearing cap 14 due to the combustion load of the internal combustion engine do not occur.

However, when the crankshaft bearing cap 13 and the control shaft bearing cap 14 are disposed in offset positions along the rotation axis of the crankshaft 6, the size of the crankshaft bearing cap 13 in the direction of the rotation axis of the crankshaft 6 must be increased so as to fix the control shaft bearing cap 14. Otherwise the size of the control shaft bearing cap 14 must be increased such that the control shaft bearing cap 14 contacts the cylinder block 1 directly. Accordingly, the length of the bolts used therefor must be increased. In either case, the bearing structure inevitably becomes large.

In the bearing structure according to this invention, since the crankshaft bearing cap 13 and the control shaft bearing cap 14 are disposed on an identical vertical plane and the first joint bolt 17 is located between the center axes of the second pair of the joint bolts 16, 18, the generation of a gap between the crankshaft bearing cap 13 and the cylinder block 1 can be prevented without causing the size of the bearing structure to become large, and the crankshaft 6 and control shaft 7 can be disposed in positions which are close in terms of a horizontal distance.

The contents of Tokugan 2007-209538, with a filing date of Aug. 10, 2007 in Japan, are hereby incorporated by reference.

Although the invention has been described above with reference to certain embodiments, the invention is not limited to the embodiments described above. Modifications and variations of the embodiments described above will occur to those skilled in the art, within the scope of the claims.

The embodiments of this invention in which an exclusive property or privilege is claimed are defined as follows:

What is claimed is:

1. A bearing structure for an internal combustion engine, the engine comprising a cylinder block, a crankshaft, and a control shaft which is disposed in parallel with the crank shaft and varies a compression ratio of the engine, comprising:
a cutout formed in the cylinder block;
a crankshaft bearing cap having a cutout which functions as a bearing bore for the crankshaft in association with the cutout of the cylinder block; and
a pair of joint bolts which fix the crankshaft bearing cap to the cylinder block, the pair of joint bolts comprising a first joint bolt which has a center axis intersecting with the control shaft.

2. The bearing structure as defined in claim 1, further comprising a control shaft bearing cap which has a cutout functioning as a bearing bore for the control shaft, and a second pair of joint bolts which fix the control shaft bearing cap to the crankshaft bearing cap in a state where the center axis of the first joint bolt is located between center axes of the second pair of joint bolts.

3. The bearing structure as defined in claim 2, wherein the first joint bolt comprises a bolt head, the crankshaft bearing cap and the control shaft bearing cap respectively comprise joint surfaces which are in contact with each other, and the crankshaft bearing cap comprises a first countersink formed in the joint surface thereof for accommodating the bolt head.

4. The bearing structure as defined in claim 2, wherein the control shaft bearing cap comprises a second countersink formed in the joint surface thereof and facing the first countersink, and the bearing structure further comprises a first positioning member which is fitted into the first countersink and the second countersink.

5. The bearing structure as defined in claim 4, wherein the control shaft bearing cap comprises a pair of through-holes which the second pair of joint bolts penetrate, the crankshaft bearing cap comprises a pair of bolt holes into which the second pair of joint bolts penetrating the pair of through-holes are screwed, the second pair of joint bolts comprises a second joint bolt which is located further from the crankshaft than another joint bolt of the second pair of joint bolts, and the bearing structure further comprises a second positioning member which is fitted into the through-hole and the bolt hole for the second joint bolt, wherein the second joint bolt penetrates the second positioning member.

6. The bearing structure as defined in claim 2, wherein the internal combustion engine further comprises a piston, an upper link connected to the piston, a lower link connected to the crankshaft via a crankpin, and a control link connected to the control shaft via a connecting pin which is offset from a rotation axis of the control shaft, wherein the upper link and the control link are connected to the lower link in different positions to the crank pin, the cylinder block and the crankshaft bearing cap respectively comprise joint surfaces which are in contact with each other, and the first joint bolt is located in a position in which a line representing an acting direction of a combustion load of the internal combustion engine on the control shaft, which is transferred from the upper link via the lower link and the control link, intersects a cross-section of the first joint bolt corresponding to the joint surfaces of the cylinder block and the crankshaft bearing cap.

7. The bearing structure as defined in any one of claim 6, wherein the control shaft bearing cap is formed from a single plate, and a radius of the control shaft is set to be equal to or greater than a sum of a distance between a center of the connecting pin and the rotation axis of the control shaft and a radius of the connecting pin.

8. The bearing structure as defined in claim 2, wherein the cylinder block comprises a plurality of cylinders, and the bearing structure comprises a first ladder beam structure comprising a plurality of control shaft bearing caps which are disposed intermittently along a rotation axis of the crankshaft and girders which connect both side ends of the respective control shaft bearing caps in an axial direction of the crankshaft.

9. The bearing structure as defined in claim 8, wherein the cylinder block further comprises a pair of walls which form a skirt of the internal combustion engine, and the bearing structure comprises a second ladder beam structure comprising a plurality of crankshaft bearing caps disposed intermittently along the rotation axis of the crankshaft, wherein both side ends of the respective crankshaft bearing caps are fixed to the pair of walls.

10. The bearing structure as defined in claim 2, wherein the crankshaft bearing cap and the control shaft bearing cap are disposed on an identical plain which is perpendicular to a rotation axis of the crankshaft.

11. The bearing structure as defined in claim 1, wherein the center axis of the first joint bolt passes through a center of the control shaft.
